(19) United States
(12) Patent Application Publication
(10) Pub. No.: US 2010/0253653 A1
(43) Pub. Date: Oct. 7, 2010

(54) VIRTUAL KNOB INTERFACE AND METHOD

(75) Inventors: Deron Stambaugh, Waterman, IL (US); Mark Mathews, Lombard, IL (US); Mark Burleson, Aurora, IL (US)

Correspondence Address: BARNES & THORNBURG LLP, P.O. BOX 2786, CHICAGO, IL, 60690-2786, US

(73) Assignee: TOUCHSENSOR TECHNOLOGIES, LLC, Wheaton, IL (US)

(21) Appl. No.: 12/752,785

(22) Filed: Apr. 1, 2010

Related U.S. Application Data
(60) Provisional application No. 61/166,575, filed on Apr. 3, 2009.

(51) Int. Cl. G06F 3/033

(52) U.S. Cl. 345/184

(57) ABSTRACT

A virtual knob interface includes a substrate, a virtual knob associated with the substrate, and a number of touch sensors associated with the substrate and with the virtual knob. The virtual knob and touch sensor are configured and arranged such that the touch sensors detect manipulation of the virtual knob by a user. The knob can be removable from the substrate. Features can be provided to disable control of a device or function controlled by the knob when the knob has been removed.

### CROSS-REFERENCE TO RELATED APPLICATIONS

This application claims priority from, and incorporates by reference the disclosure of, U.S. Provisional Patent Application No. 61/166,575, filed on Apr. 3, 2009.

### BACKGROUND OF THE INVENTION

User interfaces for appliances, industrial equipment, automobiles, electronic equipment, and the like commonly include knobs as control input devices. A conventional knob used to control, for example, a burner or oven of a gas or electric range, typically is attached to the end of a shaft extending through a perforation in an exterior panel or substrate of the range to a gas valve or rheostat. Similarly, a knob used to control the volume of a car radio or climate control system typically is attached to the end of a shaft extending through a perforation in the car's dash panel to a rheostat or rotary switch. These perforations typically are not sealed. As such, they provide a path for contaminants, for example, cooking spills, dust, and dirt, to reach and adversely affect the operation and/or service life of the associated valve, rheostat, switch, or other attached device.

### BRIEF DESCRIPTION OF THE DRAWINGS

FIG. 1A is an exploded perspective view of an illustrative embodiment of a virtual knob interface 10 including a substrate 12, a virtual knob 14 associated with one side of the substrate, an adhesive 16 for attaching the virtual knob to the substrate, and a number of touch sensors 18 disposed on a circuit carrier 20 associated with the other side of the substrate;

FIG. 1B is an exploded cross-sectional side view of an illustrative embodiment of a virtual knob interface 10 including a substrate 12, a virtual knob 14 associated with one side of the substrate, an adhesive for 16 attaching the virtual knob to the substrate, and a number of touch sensors 18 disposed on a circuit carrier 20 associated with the other side of the substrate;

FIG. 1C is a plan view of an illustrative embodiment of a circuit carrier 20 bearing a number of touch sensors 18, showing virtual knob 14 in phantom;

FIG. 1D is a plan view of another illustrative embodiment of a circuit carrier 20 bearing a number of touch sensors 18, showing virtual knob 14 in phantom;

FIG. 1E is a perspective view of another illustrative embodiment of a virtual knob 14;

FIG. 1F is a perspective view of another illustrative embodiment of a virtual knob interface 10 including a substrate 12, a virtual knob 14 integrally formed with substrate 12, and a number of touch sensors 18 disposed on a circuit carrier 20 associated with the interior surface of virtual knob 14;

FIG. 1G is another perspective view of the embodiment shown in FIG. 1F;

FIG. 2A is an exploded perspective view of an illustrative embodiment of a virtual knob interface 110 including a substrate 112, a virtual knob 114 associated with a first side of the substrate, a retention ring 124 for effecting a magnetic coupling with magnets 122 shown in FIG. 2B, thereby removably attaching the virtual knob to the control panel, and a number of touch sensors 118 disposed on a circuit carrier 120 associated with the other side of the substrate;

FIG. 2B is an exploded cross-sectional side view of an illustrative embodiment of a virtual knob interface 110 including a substrate 112, a virtual knob 114 associated with a first side of the substrate, a number of magnets 122 and a corresponding retention ring 124 for removably attaching the virtual knob to the control panel, and a number of touch sensors 118 disposed on a circuit carrier 120 associated with the other side of the substrate;

FIG. 2C is a plan view of an illustrative embodiment of a circuit carrier 120 bearing touch sensors 118 and reed switches 134;

FIG. 2D is a cross-sectional side view of another embodiment of a virtual knob interface 110 including a substrate 112, a shaft 136 projecting from the substrate, a virtual knob 114 removably mounted on the shaft, a magnet 122 and corresponding retention ring 124 for retaining the virtual knob to the shaft, and a number of touch sensors 118 disposed on a circuit carrier 120 associated with the other side of the substrate.

### DETAILED DESCRIPTION OF THE ILLUSTRATED EMBODIMENTS

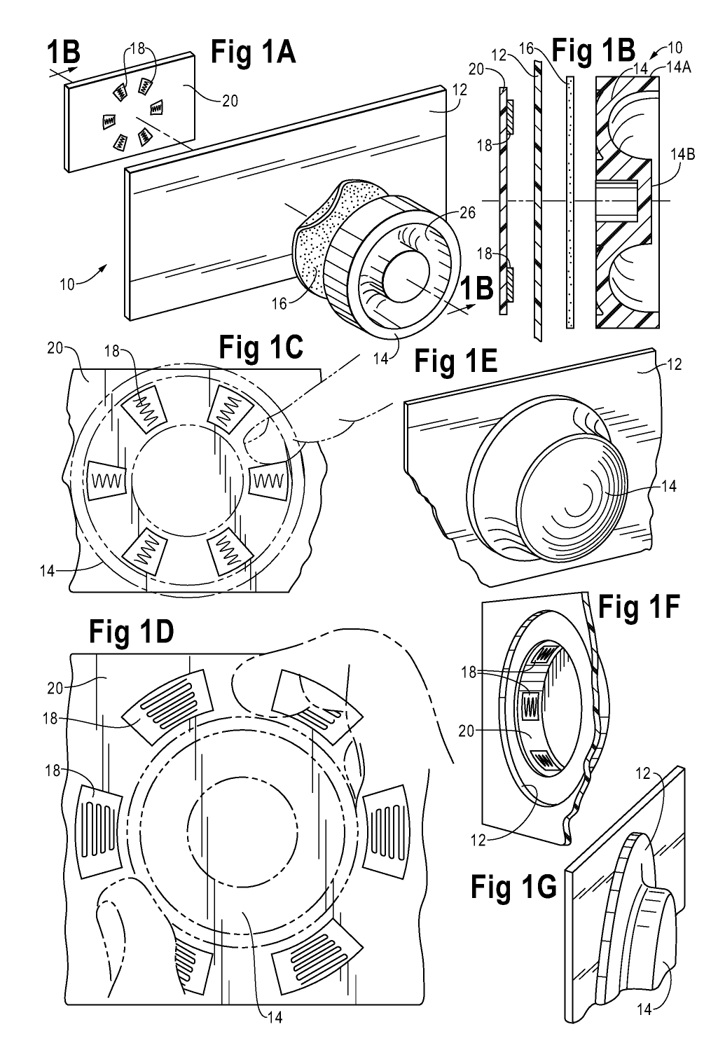

FIGS. 1A-1F illustrate a virtual knob interface 10 including a substrate 12, a virtual knob 14 affixed to substrate 12, and a number of touch sensors 18 associated with substrate 12 and with virtual knob 14. Touch sensors 18 are arranged in a manner that enables them to sense proximity or touch of a user's finger or other object to corresponding portions of virtual knob 14 and/or substrate 12, as will be discussed further below. Virtual knob 14 functions to guide the user's finger or object along a path corresponding to the arrangement of touch sensors 18. Virtual knob interface 10 may also include circuitry (not shown) for operating and processing data received from touch sensors 18.

Substrate 12 could be made of glass, plastic, wood, or any other suitable material, as would be recognized by one skilled in the art. Substrate 12 could be embodied as a panel of a corresponding controlled device, for example, a dash panel of an automobile. Alternatively, substrate 12 could be embodied as a panel attached to a corresponding controlled device, for example, a glass or plastic user interface panel attached to an appliance such as a range or dishwasher. In other embodiments, substrate 12 could be part of a control panel located remotely from a corresponding controlled device, for example, a tethered or wireless remote control or other control or user interface panel.

Touch sensors 18 could be embodied as any suitable form of sensor that can be actuated by proximity or touch of a user's finger or other object, as would be recognized by one skilled in the art. For example, touch sensors 18 could be embodied as one or more sensing electrodes coupled to a TS-100 ASIC available from TouchSensor Technologies, LLC of Wheaton, Ill. (“TouchSensor”). Such touch sensors are described in U.S. Pat. No. 6,320,282 and related patents and applications. Alternatively, touch sensors 18 could be embodied as the touch sensors disclosed in U.S. Pat. Nos. 5,594,222 and 6,310,611 assigned to TouchSensor. These references disclose touch sensors including a substantially planar or electrode in the form of a conductive pad and could further include an electrode substantially surrounding the conductive pad. Such sensing electrodes could be curved, as well, to conform to a curved surface. These references also disclose control circuits that generates an electric field extending generally perpendicularly from such sensing electrode(s) and, therefore, from a surface on which the sensing electrode(s) might be located, as would be understood by one skilled in the art. The control circuits detect disturbances to the electric field caused by proximity of a stimulus, for example, a user's finger or other object. In other embodiments, touch sensors 18 could be embodied as capacitive touch sensors having one or more sensing electrodes and corresponding control circuitry, as would be understood by one skilled in the art.

Touch sensors 18 and/or the sensing electrodes thereof are shown as being disposed on a circuit carrier 20, which in turn is attached to substrate 12. Alternatively, touch sensors 18 could be at least partially embedded within circuit carrier 20. In other embodiments, touch sensors 18 could be disposed directly onto substrate 12 or at least partially embedded within substrate 12. In such embodiments, circuit carrier 20 could be omitted, or it could be provided to carry other circuitry.

When used, circuit carrier 20 could be any suitable form of rigid or flexible circuit carrier, as would be recognized by one skilled in the art. For example, circuit carrier 20 could be embodied as a rigid substrate, such as a printed wiring board made of FR4 or other suitable material. In other embodiments, circuit carrier 20 could be a flexible circuit carrier made of polyester or other suitable material. Circuit carrier 20 could be attached to substrate 12 in any suitable manner. For example, circuit carrier 20 could be attached to substrate using adhesives, mechanical fasteners, snap-fit structures, and/or other means, as would be recognized by one skilled in the art.

Virtual knob 14 is illustrated as a generally circular disc having a perimeter portion 14A and a face 14B. Perimeter portion 14A is shown in FIG. 1B as being generally perpendicular to face 14B. In other embodiments, perimeter portion 14A could be angled with respect to face 14B. Perimeter portion 14A could be configured otherwise, as well. Although virtual knob 14 is shown as disc-shaped, it could take other forms, as well. For example, virtual knob could be configured as square, rectangular, ovoid, or any other suitable regular or irregular shape.

As set forth above, virtual knob 14 functions to guide a user's finger or other object along a path corresponding to the arrangement of touch sensors 18 associated with substrate 12. In some embodiments, for example, the embodiment shown in FIG. 1D, touch sensors 18 could be arranged on substrate 12 in a pattern generally corresponding to the perimeter of virtual knob such that a user's finger or other object tracing a path about the perimeter of virtual knob 14 generally would pass over (the sensing electrodes of) touch sensors 18. In such embodiments, touch sensors 18 generally would be arranged in a pattern lying outside the perimeter of virtual knob 14, although virtual knob 14 could at least partially overlie touch sensors 18.

In other embodiments, for example, the embodiments shown in FIGS. 1A-1C, virtual knob 14 could include a groove 26 formed into perimeter portion 14A or face 14B thereof and touch sensors 18 could be arranged in a pattern generally corresponding to groove 26 such that a user's finger or other object tracing a path about groove 26 would pass over (the sensing electrodes of) touch sensors 18. Groove 26 is shown in FIGS. 1A-1C as being located at or near the perimeter of virtual knob 14 and depending from face 14B thereof. In other embodiments, groove 26 could be located nearer the center of virtual knob 14. In further embodiments, groove 26 could be located at the interface between perimeter portion 14A and face 14B of virtual knob 14, as shown in, for example, FIG. 1E. Groove 26 could be located elsewhere, as well.

Groove 26 is shown in FIGS. 1A-1C as a continuous groove having a uniform cross-section. Groove 26 could have other shapes and cross-sections, as well. For example, groove 26 could be a discontinuous groove of constant or decreasing radius arranged in, for example, a spiral pattern. In other embodiments, groove 26 could be arranged in a linear or other regular or irregular shape. Further, the cross section of groove 26 could vary. For example, groove 26 could be embodied as a number of interconnected depressions or scallops. The number and placement of such scallops could, but need not, correspond to the number and placement of touch sensors 18 associated with substrate 12 and virtual knob 14. In other embodiments, the depth and/or width of groove 26 and/or the texture of the surface thereof could vary from one end to the other to provide tactile feedback indicative of, for example, raising or lowering a volume, lighting, or temperature level. For example, groove 26 could be relatively narrow and shallow at one end and relatively deep and wide at the other end. As another example, the surface of groove 26 could have a smooth or relatively smooth texture at one end and a rougher texture at the other end.

Virtual knob 14 is shown in FIGS. 1A-1E as a discrete structure affixed to a surface of substrate 12 by means of adhesive 16. Adhesive 16 could be any suitable adhesive, as would be recognized by one skilled in the art. For example, adhesive 16 could be embodied as glue, epoxy, or double-sided tape. Alternatively, virtual knob 14 could be affixed to substrate 12 by other suitable means as would be recognized by one skilled in the art. For example, virtual knob 14 could be affixed to substrate 12 using mechanical fasteners, such as screws, snap-fit structures, and the like, as would be recognized by one skilled in the art. Such snap-fit structures could include posts projecting from substrate 12 and receptacles located on or in virtual knob 14 or vice versa. Preferably, such mechanical fasteners would not perforate substrate 12.

In other embodiments, virtual knob 14 could be removably attached to substrate 12 using, for example, releasable adhesives, hook and loop fasteners or press-fit structures in place of adhesive 16. Such press-fit structures could include posts extending from substrate 12 and corresponding receptacles on or in virtual knob 14 or vice versa. Preferably, such structures would not perforate substrate 12. In such embodiments, virtual knob interface 10 could be provided with reed switches and magnets (similar to reed switches 128 and magnets 122 discussed further below) for detecting the presence or absence of virtual knob 14. Such reed switches could be incorporated into control circuitry that could disable the device or function controlled by virtual knob interface 10 in the absence of virtual knob 14.

FIGS. 1F-1G illustrate an alternate embodiment wherein virtual knob 14 is integrally formed with substrate 12. This structure could be produced using, for example, injection molding or thermoforming processes. In such embodiments, touch sensors 18 can be arranged in the interior region of virtual knob 14 in any of the manners discussed above.

Touch sensors 18 could be tuned or calibrated such that they would not be actuated by touch or proximity to portions of virtual knob 14 or substrate 12 other than the portions directly overlying touch sensors 18 or the sensing electrodes thereof.

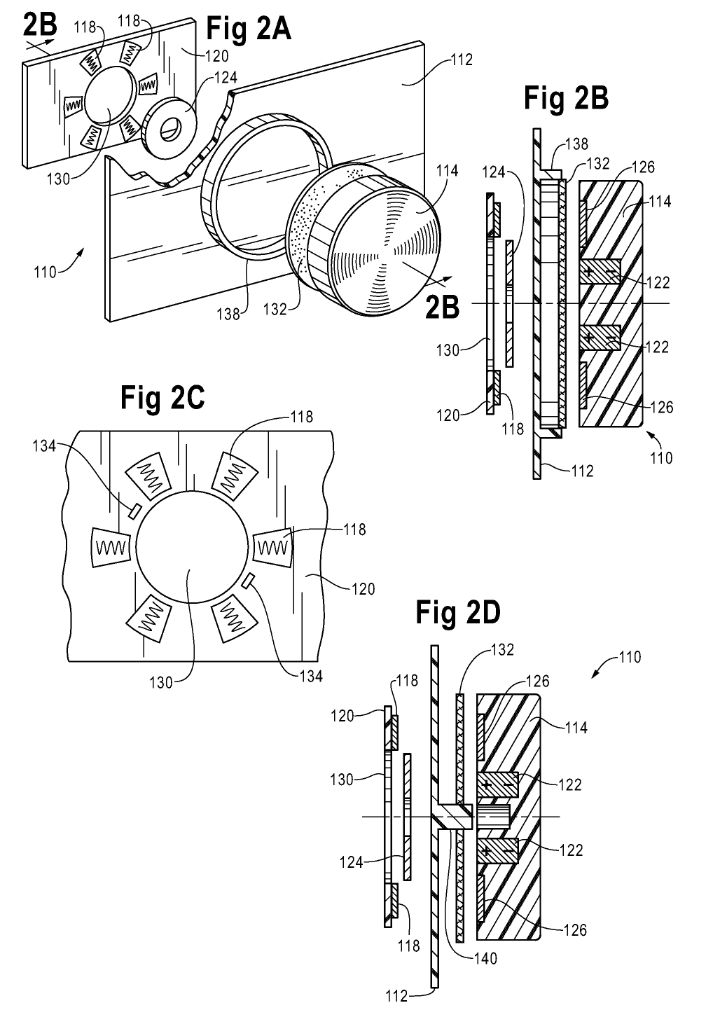

FIGS. 2A-2C illustrate a virtual knob interface 110 including a substrate 112, a virtual knob 114 associated with substrate 112, a retention ring 124 associated with substrate 112, and a number of touch sensors 118 associated with substrate 112 and with virtual knob 114. Virtual knob 114 includes a number of magnets 122 that magnetically couple with retention ring 124, thereby magnetically attaching virtual knob 114 to the surface of substrate 112 in a manner that allows rotation of virtual knob 114 with respect to substrate 112. Virtual knob 114 also includes a number of conductive masses 126. Conductive masses 126 and touch sensors 118 are arranged in a manner that enables individual ones of touch sensors 118 to detect the presence of individual ones of conductive masses 126 when such conductive masses are moved into proximity with such touch sensors in response to rotation of virtual knob 114. Virtual knob interface 110 also may include circuitry (not shown) for operating and processing data received from touch sensors 118. Virtual knob interface 110 may further include one or more reed switches 128 associated with substrate 112 and corresponding control circuitry for detecting the presence of virtual knob 114, as will be discussed further below.

Substrate 112 is generally analogous to, and generally can have the attributes of, substrate 12 discussed above. Touch sensors 118 are generally analogous to, and generally can have the attributes of, touch sensors 20 discussed above. Touch sensors 118 and/or the sensing electrodes thereof could be disposed directly onto or partially or fully embedded within substrate 112. Alternatively, touch sensors 118 could be disposed on or at least partially embedded within a circuit carrier 120, which generally is analogous to, and generally can have the attributes of, circuit carrier 20, discussed above. As shown in FIGS. 2A-2C, circuit carrier 120 could include a perforation 130 or a recess (not shown) that could accommodate retention ring 124, thus allowing both retention ring 124 and circuit carrier 120 to substantially abut substrate 112.

Retention ring 124 could be a magnetic coupler in the form of a magnet or ferromagnetic ring associated with substrate 112. Retention ring 124 could be attached to substrate 112 in numerous ways. For example, retention ring 124 could be adhered to substrate 112 using an adhesive or mechanical fasteners, as discussed above. In other embodiments, retention ring 124 could be partially or fully embedded in substrate 112. Alternatively, retention ring 124 could be attached to or embedded within circuit carrier 120, which in turn could be attached to the rear surface of substrate 112. In such embodiments, retention ring 124 could be attached to circuit carrier 120 in any suitable way. For example, retention ring 124 could be press-fit into and/or adhesively attached to perforation 130 of circuit carrier 120 or a recess in circuit carrier 120. In other embodiments, retention ring 124 could be surface mounted to circuit carrier 120 using any suitable means. In other embodiments, discrete magnets (not shown) or ferromagnetic elements (not shown) could replace retention ring 124.

Virtual knob 114 is shown as a disc including a number of magnets 122 and conductive masses 126 therein. Virtual knob 114 could have other shapes, as well. For example, virtual knob 114 could have a square, ovoid, or other regular or irregular shape. Magnets 122 and/or conductive masses 126 could be molded or otherwise embedded into virtual knob 114 or otherwise attached thereto. Virtual knob 114 is shown as including two magnets 122 and two conductive masses 126, but virtual knob 114 could include more or fewer magnets 122 and conductive masses 126. When virtual knob 114 is brought near retention ring 124, magnets 122 magnetically couple with retention ring 124 and the associated magnetic force removably secures virtual knob 114 to substrate 112. A damper 132 made of felt or other suitable material could be provided to prevent direct contact of virtual knob 114 with substrate 112. Damper 132 could be affixed to the rear surface of virtual knob 114 or to the face of substrate 112 using an adhesive, a hook and loop fastener, or other means.

The magnetic coupling between magnets 122 and retention ring 124 could alone be sufficient to locate virtual knob 114 in the desired position on substrate 112, as would be understood by one skilled in the art. Increasing the number of magnets 122 provided in association with virtual knob 114 could improve the tendency of the magnetic coupling to locate virtual knob 114 in the desired position. In other embodiments, as shown in FIG. 2A, substrate 112 could include an optional lip 138 projecting therefrom to help locate virtual knob 114 and help preclude undesirable lateral movement of virtual knob 114 with respect to substrate 112, for example, when virtual knob 114 is manipulated by a user. Where provided, lip 138 could be integrally formed with substrate 112 or it could be a separate component, for example, a plastic ring, attached to substrate 112. Lip 138 is shown as a continuous ring, but could be embodied as any structure, for example, a “ring” with segments thereof removed, capable of receiving a portion of or otherwise locating virtual knob 114 with respect to substrate 112.

Other means could be provided to locate virtual knob 114 in the desired position with respect to substrate 112. For example, as shown in FIG. 2D, virtual knob 114 could be removably mounted on shaft 140 extending from substrate 112. Shaft 140 could be integrally formed with substrate 112 or it could be a discrete component attached thereto using, for example, adhesives, mechanical means, or other means. The magnetic coupling between magnets 122 and retention ring 124 could be sufficient to retain virtual knob 114 on shaft 140. Alternatively, virtual knob 114 could be removably retained to shaft 140 using other suitable means, for example, detent mechanisms, as would be understood to those skilled in the art. In other embodiments, virtual knob 114 could be relatively permanently attached using snap fit joints, and the like, as would be understood to those skilled in the art. In embodiments not relying on magnets 122 and retention ring 124 to retain virtual knob 114 to substrate 112, these elements could be omitted. Alternatively, magnets 122 could be retained to actuate reed switches 128, as discussed further below.

Virtual knob 114 could be removed from substrate 112 by simply applying enough pull or lateral force to overcome the magnetic force between magnets 122 and retention ring 124 that otherwise attaches virtual knob 114 to substrate 112. As such, virtual knob 114 could readily be removed and replaced with another virtual knob 114 having a different color or general appearance, thus simplifying customization (particularly by an end user) of a control panel using virtual knob interface 110.

Various features could be provided to preclude operation of the device or function controlled by virtual knob 114 when virtual knob 114 is removed from substrate 112. For example, virtual knob interface 110 could include a control circuit that enables operation of the device or function controlled by virtual knob interface 110 only if the control circuit receives simultaneous or near-simultaneous input from any two or more, or a specific two or more, of touch sensors 118. Such actuation would be difficult to simulate by an unauthorized user attempting to stimulate touch sensors 118 by simply placing the user's finger or other object in proximity to portion of substrate 112 corresponding to touch sensors 118 in the absence of virtual knob 114.

Further, one or more reed switches 128 could be associated with substrate 112 in a manner that enables the reed switches to open and close in response to the presence or absence of the magnetic field about magnets 122. FIGS. 2A-2C illustrate an embodiment wherein reed switches 128 are located on circuit carrier 120. Alternatively, reed switches 128 could be located elsewhere, for example, on substrate 112. Reed switches 128 could be incorporated into a control circuit such that the reed switches disable operation of the controlled device or function associated with virtual knob interface 110 when virtual knob 114 is not attached to substrate 112 and enable operation of the controlled device or function when virtual knob 114 is attached to substrate 112. In such embodiments, mere proximity or touch of a user's finger or other object to substrate 112 in areas corresponding to touch sensors 118 would be insufficient to operate the controlled device unless virtual knob 114 were present. Other embodiments could use other technologies, for example, RFID tagging, Bluetooth, and optical scanning, to determine the presence or absence of virtual knob 114.

In any of the foregoing embodiments, touch sensors 18,118 could be coupled to a control circuit including means for generating a signal to excite the touch sensors, and for detecting an event actuating the touch sensors, for example, the proximity or touch of a user's finger or other object to virtual knob 14 or substrate 12 or the movement of conductive masses 126 in and out of proximity to touch sensors 18,118, as would be recognized by one skilled in the art. Such a control circuit could further include means for determining, based on signals received from individual ones of touch sensors 18,118, the speed, direction, and angular displacement or other extent of movement of the user's finger, other object, or conductive mass relative to touch sensors 18,118, as would be understood by one skilled in the art.

In alternate embodiments, one or more optical sensors could take the place of touch sensors 118. In such embodiments, virtual knob 114 need not include conductive masses 126.

In yet another embodiment, touch sensors 118 could be arranged relative to virtual knob 114 in a manner similar to that shown in FIG. 1D. In such an embodiment, touch sensors 118 would respond to proximity of an object moving about the perimeter of virtual knob 114. For example, touch sensors 118 would respond to the proximity of a user's finger(s) and/or thumb grasping virtual knob 114 as the user rotates virtual knob 114. In such embodiments, virtual knob 114 need not include conductive masses 126.

Substrates 12,112 are shown as including only a single virtual knob interface 10,110. In other embodiments, substrates 12,112 could include multiple virtual knob interfaces 10,110, as well as other switching mechanisms, indicators, displays, annunciators, and the like (not shown).

Virtual knob 14,114 could include haptic feedback, lighting, and/or other active features. Haptic feedback could be provided by one or more haptic feedback generators, for example, vibrators, mounted in or on virtual knob 14,114. Lighting could be embodied as one or more lamps, LEDs or other light sources located in or on virtual knob 14,114. Such devices could be powered by one or more batteries located in virtual knob 14,114, by means of an inductive coupling associated with, for example, substrate 12,112 or circuit carrier 20,120, or by another suitable power source. Virtual knob 14,114 also could be illuminated by means of an optical coupling between virtual knob 14,114 and a light source located on substrate 12,112, circuit carrier 20,120, or other elsewhere. Such an optical coupling could include one or more light pipes for conveying light from the light source to virtual knob 14,114 and a diffuser. Such lighting and haptic feedback could be selectively energized in response to manipulation of virtual knob 14,114, to identify or draw attention to virtual knob 14,114, or otherwise.

This disclosure illustrates and describes certain embodiments of a virtual knob interface. The disclosure is not intended to limit the scope of the present invention, and one skilled in the art would recognize that these embodiments could be modified without departing from the scope of the present invention, which is defined by the following claims.

1. A virtual knob interface comprising:
a substrate;
a plurality of touch sensors, each of said touch sensors comprising at least one sensing electrode associated with said substrate, each of said touch sensors adapted to emit an electric field about the respective at least one sensing electrode;
a virtual knob associated with said substrate and said plurality of touch sensors, said virtual knob defining a guide corresponding to the locations of said electric fields, said guide being adapted for navigation by a stimulus external to said virtual knob.

2. The virtual knob interface of claim 1 wherein said touch sensor sensing electrodes are disposed on said substrate.

3. The virtual knob interface of claim 1 wherein said touch sensor sensing electrodes are disposed on a circuit carrier and said circuit carrier is disposed on said substrate.

4. The virtual knob of claim 3 wherein said circuit carrier comprises a flexible circuit carrier.

5. The virtual knob interface of claim 3 wherein said circuit carrier comprises a printed wiring board.

6. The virtual knob interface of claim 1 wherein said virtual knob is substantially permanently and non-rotatbly attached to said substrate.

7. The virtual knob interface of claim 6 further comprising an adhesive securing said knob to said substrate.

8. The virtual knob interface of claim 1 wherein said knob is an integral portion of said substrate.

9. The virtual knob interface of claim 1 wherein said knob comprises a recessed portion, said recessed portion defining said path.

10. The virtual knob interface of claim 9 wherein said recessed portion is oriented about the periphery of said knob.

11. The virtual knob interface of claim 10 wherein said recessed portion depends from the face of said knob.

12. The virtual knob interface of claim 1 wherein said virtual knob is removably and non-rotatably attached to said substrate.

13. The virtual knob interface of claim 12 further comprising means for disabling a device or function controlled by said virtual knob interface when said virtual knob is removed from said substrate.

14. The virtual knob interface of claim 12 further comprising at least one reed switch associated with said substrate, said at least one reed switch adapted to disable a device or function controlled by said virtual knob interface when said virtual knob is removed from said substrate.

15. The virtual knob interface of claim 1 wherein said stimulus comprises a user's finger or other object.

16. A virtual knob interface comprising:
a substrate;
a plurality of touch sensors associated with said substrate;
a virtual knob associated with said substrate and said plurality of touch sensors, said virtual knob comprising at least one conductive mass arranged to move along a path corresponding to the locations of said touch sensors in response to rotation of said knob;
and means for removably retaining said virtual knob to said substrate.

17. The virtual knob interface of claim 16 wherein said means for removably retaining said virtual knob to said substrate comprises at least one magnet disposed in said virtual knob and a corresponding magnetic coupler associated with said substrate.

18. The virtual knob interface of claim 17 further comprising a lip associated with said substrate, said lip adapted to locate said virtual knob with respect to said virtual knob.

19. The virtual knob interface of claim 16 further comprising a damper disposed between said knob and said substrate.

20. The virtual knob interface of claim 16 further comprising a control circuit adapted to determine speed, direction, and extent of rotation of said virtual knob in response to signals received from individual ones of said touch sensors.

21. The virtual knob interface of claim 16 further comprising a control circuit adapted to disable a device or function controlled by said virtual knob interface when said virtual knob is removed from said substrate.

22. The virtual knob interface of claim 16 further comprising a control circuit adapted to disable a device or function controlled by said virtual knob interface when said virtual knob is removed from said substrate and at least one reed switch associated with said substrate, said reed switch providing an input to said control circuit.
